(19) United States
(12) Patent Application Publication
(10) Pub. No.: US 2026/0074986 A1
(43) Pub. Date: Mar. 12, 2026

(54) CLOUD-BASED LOAD BALANCING FOR SOFTWARE-DEFINED WIDE AREA NETWORKS

(71) Applicant: Hewlett Packard Enterprise Development LP, Spring, TX (US)

(72) Inventors: Laura Neacsu, Berkeley Heights, NJ (US); Dilip Gupta, Santa Clara, CA (US)

(21) Appl. No.: 18/828,480

(22) Filed: Sep. 9, 2024

(51) Int. Cl. H04L 45/28; H04L 45/64; H04L 45/76

(52) U.S. Cl. CPC H04L 45/28; H04L 45/64; H04L 45/76

(57) ABSTRACT

An overlay network is configured to logically connect a first data center, a second data center, a core, and a branch. The first data center is directed to advertise routes of the overlay network to the core, the routes being associated with the branch and establishing a routing path for traffic from the branch through a first overlay tunnel between the branch and the first data center. The first overlay tunnel is monitored for a loss of connectivity. In response to detecting the loss of connectivity of the first overlay tunnel the second data center is directed to advertise the routes of the overlay network to the core. The routes advertised by the second data center reestablish the routing path for traffic from the branch through a second overlay tunnel between the branch and the second data center.

### BACKGROUND

Overlay networking allows the creation of a virtual network that runs on a physical network. It enables abstraction of the underlying network devices, providing flexibility, scalability, and isolation in a network. In overlay networking, a virtual network may be created using software-defined networking techniques. Network packets may traverse the physical network while appearing as if they belong to a virtual network.

Software-defined wide area networks (SD-WANs) represent a specific application of overlay networking principles to wide area networks. SD-WANs use software-defined networking to direct traffic across WANs, often combining multiple connection types such as MPLS, broadband internet, and cellular networks. This technology enables organizations to increase their network performance, reduce costs, and improve application delivery across distributed locations. SD-WANs address some challenges of traditional wide area networks (WANs) by providing centralized control, dynamic path selection, and application-aware routing. However, as overlay networks and SD-WANs grow in complexity and scale, managing routing and traffic flow becomes increasingly challenging.

### BRIEF DESCRIPTION OF THE DRAWINGS

For a more complete understanding of this disclosure, and advantages thereof, reference is now made to the following descriptions taken in conjunction with the accompanying drawings.

FIG. 1 is a block diagram of a network system, according to some implementations.

FIGS. 2A-2B illustrate an SD-WAN configuration for a network system, in accordance with some implementations.

FIG. 3 is a flow diagram of an SD-WAN load balancing method, according to some implementations.

FIG. 4 is a flow diagram of an SD-WAN load balancing method, according to some implementations.

Corresponding numerals and symbols in the different figures generally refer to corresponding parts unless otherwise indicated. The figures are drawn to clearly illustrate the relevant aspects of the disclosure and are not necessarily drawn to scale.

### DESCRIPTION

The following disclosure provides many different examples for implementing different features. Specific examples of components and arrangements are described below to simplify the present disclosure. These are, of course, merely examples and are not intended to be limiting.

Modern overlay network architectures may utilize multiple data centers for redundancy and load distribution. However, the use of multiple data centers presents challenges. One issue is the processing of control traffic (and specifically, route advertisements) by the core of the overlay network. In some systems, while operational traffic is directed to a primary data center under normal circumstances, control traffic generated by route advertisement is still sent to both the primary and backup data centers. The primary and backup data centers process these route advertisements and also forward them to the network core for processing. This processing of route advertisements forward from the backup data center – potentially even when the backup data center is inactive – burdens the network core, consuming computational resources and potentially impacting the overall efficiency of the network.

The present disclosure describes cloud-based load balancing for Software-Defined Wide Area Networks (SD-WANs). The system includes a cloud-based software-defined networking orchestrator service that manages an SD-WAN. During normal operation, the cloud-based SD-WAN orchestrator sends route advertisements to the primary data center but withholds them from the backup data center. The route advertisements may be held at the cloud-based SD-WAN orchestrator and released to the backup data center when needed, such as during failover. By withholding route advertisements from the backup data center under normal conditions, the SD-WAN may exercise more control over route advertisements to the backup data center (and, by proxy, the network core). As a result of this approach, overlay routes may be primarily advertised to the network core through the primary data center during normal operation, and may only be advertised to the network core through the backup data center during failover. This may reduce the amount of control traffic that is processed by the core, thereby conserving computational resources and enhancing overall network efficiency.

To accomplish failover, the SD-WAN orchestrator monitors the status of tunnels connecting network branches to the primary data center. In the event of a primary tunnel failure, the SD-WAN orchestrator begins advertising the routes of the overlay network to the backup data center. This effectively redirects branch traffic to the backup data center, at which point the network core may begin processing route advertisements from the backup data center. Thus, connectivity to the branches may be maintained while route advertisement processing in the core may be deferred until a failover. This approach may be particularly advantageous when the network core has fewer routing resources than the data centers, such as when the network devices in the core have smaller routing table capacities than the network devices in the data centers.

In overlay networks where virtual routing and forwarding (VRF) is utilized, this selective route advertising may be performed on a per-VRF segment basis. Thus, different routing and load-balancing instances may be supported within different overlays of the same overlay network. This granular control allows network administrators to tailor the load balancing strategy to the specific requirements of different network segments or applications.

By intelligently managing the flow of control traffic and controlling advertisements of routes of the overlay network, the cloud-based load balancing described herein may improve the efficiency, cost-effectiveness, and scalability of SD-WAN deployments. Further, it may address the technical problem of unnecessary resource consumption in multi-data center architectures while providing a mechanism for maintaining network connectivity during failover events.

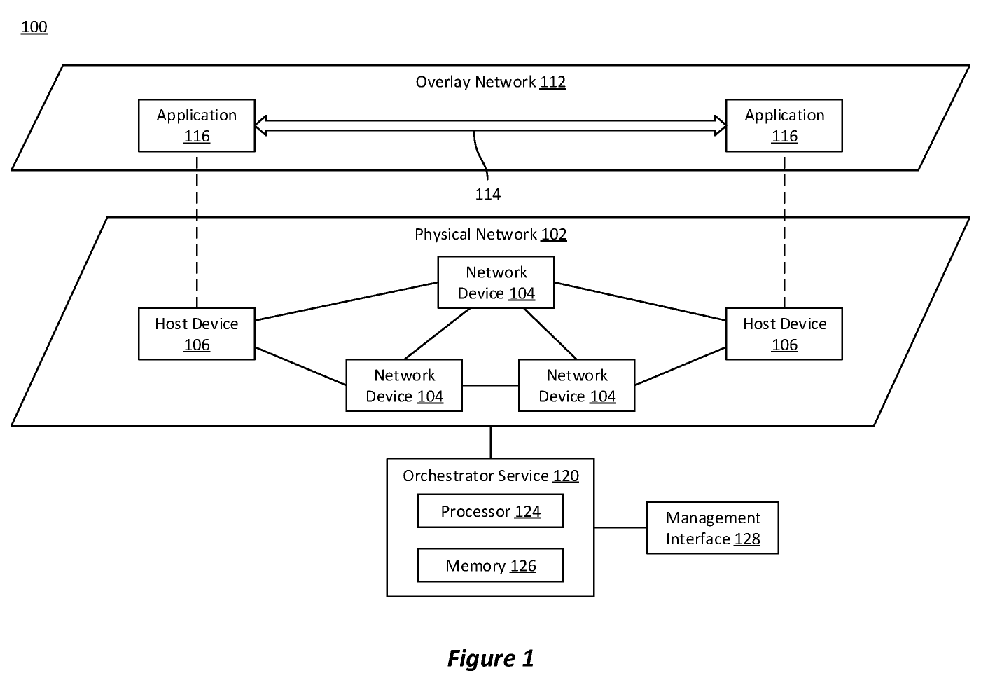

FIG. 1 is a block diagram of a network system 100, according to some implementations. The network system 100 includes a physical network 102. Overlay networking may be used to orchestrate the network system 100 so that an overlay network 112 runs on the physical network 102. Overlay networking allows for greater flexibility and scalability in network design and management, as the overlay network 112 may be reconfigured without changing the underlying physical network 102.

The physical network 102 includes multiple network devices 104. The network devices 104 may be controllers, access points, switches, routers, or the like. Additionally, the physical network 102 includes host devices 106. The host devices 106 may be bare metal machines that are adapted to run applications 116 (e.g., server programs, client programs, virtual machines, containers, etc.). The network devices 104 form a transit network that provides connectivity and routing between the host devices 106. At least some of the network devices 104 and the host devices 106 may be located in on-premises data centers (subsequently described), but the physical network 102 may span across multiple locations. The physical network 102 may be a Layer 2 network.

The overlay network 112 is established on the physical network 102 using an encapsulation protocol. An encapsulation protocol encapsulates network traffic within a routing path 114, which is transmitted via the network devices 104. Example encapsulation protocols include Virtual Extensible LAN (VXLAN), Generic Routing Encapsulation (GRE), and the like. These protocols wrap the original network packets with additional headers that contain information about the overlay network, allowing the encapsulated packets to be routed through the physical network while maintaining the logical structure of the overlay network. Encapsulation allows the overlay network 112 to operate as if it were a dedicated physical infrastructure, even though the traffic is actually transported over the physical network 102. The applications 116 running on the host devices 106 may be connected via routing paths 114. The routing paths 114 may be established and managed by the orchestrator service 120 to direct traffic between specific applications 116 via the network devices 104 and the host devices 106. The overlay network 112 may be a Layer 3 network.

An orchestrator service 120 is adapted to manage the network system 100. Specifically, the orchestrator service 120 may be used to configure the overlay network 112, such as by creating or modifying the routing paths 114. The orchestrator service 120 may do so by configuring the network devices 104 and the host devices 106 of the physical network 102, such as by applying device configurations to the network devices 104 and the host devices 106.

The orchestrator service 120 may include any suitable components. Suitable components include a processor, an application-specific integrated circuit, a microcontroller, memory, and the like. The orchestrator service 120 may include one or more host devices, e.g., servers. For example, the orchestrator service 120 may include a server that includes processor 124 and a memory 126. The memory 126 may be a non-transitory computer readable medium that stores instructions for execution by the processor 124. One or more modules within the orchestrator service 120 may be partially or wholly implemented as software and/or hardware for performing any functionality described herein.

The orchestrator service 120 may be an on-premises service or may be a cloud service. When the orchestrator service 120 is an on-premises service, it may be part of the physical network 102, such as in an on-premises data center. When the orchestrator service 120 is a cloud service, it may be part of another physical network that is different than the physical network 102. In either case, the orchestrator service 120 is adapted to communicate with the network devices 104.

The orchestrator service 120 receives commands from a management interface 128 and displays output with the management interface 128. The management interface 128 may be a command line interface, a graphical user interface, a web interface, or the like. The orchestrator service 120 processes the commands from the management interface 128, validates the commands, and executes logic specified by the commands. Further, the orchestrator service 120 outputs the results of commands via the management interface 128.

In the network system 100, an SD-WAN may be implemented to connect geographically distributed branch offices to data centers and cloud resources. The SD-WAN leverages the physical network 102 and the overlay network 112, allowing an organization to utilize multiple connection types to enhance network performance and reduce costs. Some of the network devices 104 and the host devices 106 may be part of data centers, while others of the network devices 104 and the host devices 106 may be part of a network core. The overlay network 112, established using encapsulation protocols, provides a logical abstraction of the underlying physical infrastructure, enabling more flexible and centralized management of network resources through the orchestrator service 120.

The overlay network 112 may provide the logical abstraction layer that is characteristic of SD-WAN technology, allowing for the creation of routing paths 114 that span across the underlying physical infrastructure. The routing paths 114 may represent the logical connections that an SD-WAN establishes and manages, potentially combining multiple physical connection types such as MPLS, broadband internet, and cellular networks. The orchestrator service 120 may be an SD-WAN orchestrator service for managing the SD-WAN. The orchestrator service 120 may perform tasks such as monitoring connection quality, making real-time routing decisions, applying security policies across the network, and the like.

The orchestrator service 120 may manage two types of network traffic: control traffic and data traffic (also known as operational traffic). Data traffic includes the data for the applications 116 being transmitted across the network. Control traffic includes management and signaling information for operation of the network devices 104, such as routing updates, tunnel establishment messages, policy configurations, and the like. Route advertisements are a component of control traffic. Route advertisements are messages that the network devices 104 use to inform other devices about the network paths they can reach. Some of the network devices 104, such as routers, use the routing advertisements to build and maintain routing tables. As the network devices 104 receive route advertisements, they update their routing tables with the new path information, allowing them to make informed decisions about how to forward data traffic across the network. Route advertisements may contribute to network congestion, particularly in large-scale networks, and the resulting expansive routing tables in large-scale networks may consume significant computational and memory resources on the network devices 104.

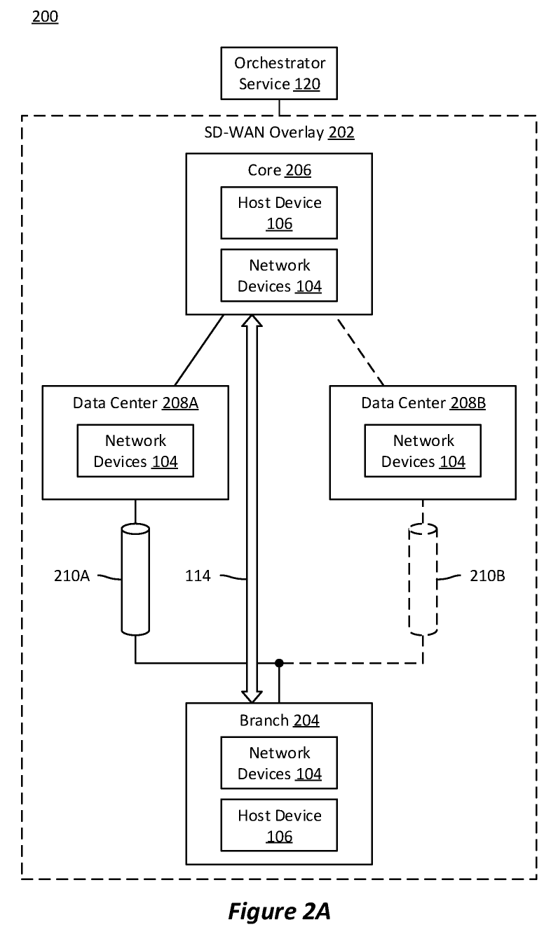

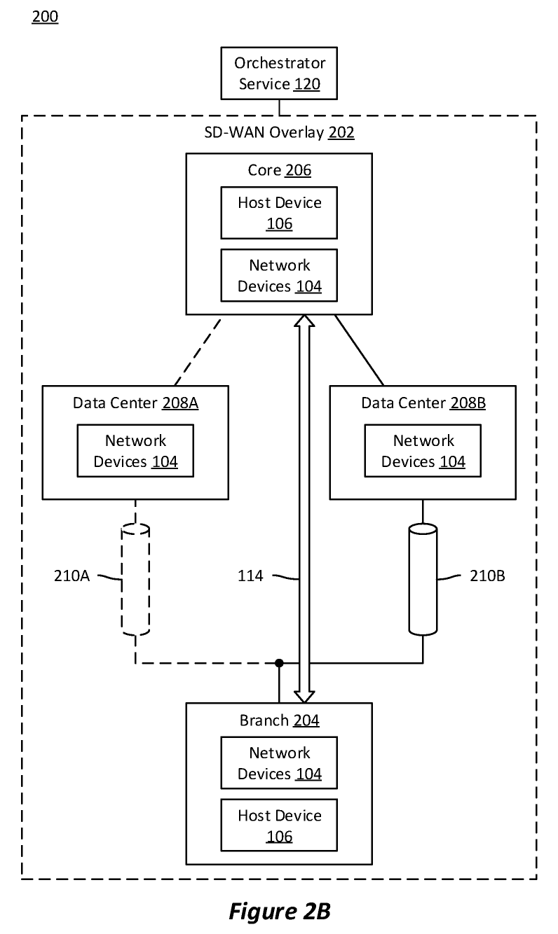

FIGS. 2A-2B illustrate an SD-WAN configuration 200 for the network system 100, in accordance with some implementations. The SD-WAN configuration 200 includes an SD-WAN overlay 202 managed by an orchestrator service 120, which may function as a software-defined networking orchestrator service. The orchestrator service 120 configures the SD-WAN overlay 202 to logically connect the various components of the network system 100. The SD-WAN overlay 202 provides a virtual network layer (e.g., overlay network 112, see FIG. 1) that abstracts and manages the underlying physical network infrastructure (e.g., physical network 102, see FIG. 1), enabling centralized control of wide area network connections by the orchestrator service 120. The SD-WAN overlay 202 includes a branch 204, a core 206, and data centers 208 (including a primary data center 208A and a secondary data center 208B).

The branch 204 represents a remote location or office within the SD-WAN configuration 200. It includes some of the host devices 106 and the network devices 104 (previously described), which may include clients that access applications and services hosted in the core 206. The branch 204 may be one of many geographically distributed branches 204 (not separately illustrated) that are logically connected to one another and the core 206 in the SD-WAN overlay 202.

The core 206 includes some of the host devices 106 and the network devices 104 (previously described). The core 206 may house resources and services that branches 204 access during operation. For example, the core 206 may include one or more server applications running on host devices 106. These server applications may be accessed by client applications at the branches 204. The network devices 104 in the core 206 may facilitate the routing and delivery of requests from the host devices 106 running applications at the branches 204, as well as the return of responses back to the branches 204. The network devices 104 in the core 206 may have sufficient resources to allow the host devices 106 in the core 206 to serve the branch clients, but may not be equipped to handle a large volume of network transit processing.

The data centers 208 operate as transit networks between the branches 204 and the core 206. A data center 208 includes some of the network devices 104, which may include routers, switches, and other networking equipment. These network devices 104 are responsible for processing and routing network traffic within the SD-WAN configuration 200. The data centers 208 facilitate both east-west communication (between branches 204) and north-south communication (between a branch 204 and the core 206). They serve as intermediary points in the network topology, receiving traffic from a branch 204 and forwarding the traffic to its destination, whether that be another branch 204 or the core 206. The network devices 104 in the data centers 208 may have substantial resources to handle a large volume of network transit processing. In some implementations, the data centers 208 may have larger routing table capacities compared to the core 206, allowing them to handle more detailed routing information. For example, the routers of the data centers 208 may have more memory than the routers of the core 206.

A branch 204 may be connected to the data centers 208 by multiple overlay tunnels 210 (including a first overlay tunnel 210A and a second overlay tunnel 210B). When there are multiple branches 204, each branch 204 may have overlay tunnels 210 to appropriate ones of the data centers 208, in a one-to-many configuration. In this example, the first overlay tunnel 210A connects a branch 204 to the primary data center 208A, while the second overlay tunnel 210B connects the same branch 204 to the secondary data center 208B. The overlay tunnels 210 are virtual connections that operate on top of the underlying physical network infrastructure. These tunnels encapsulate traffic from the branches 204, allowing it to traverse the physical network while maintaining logical separation and security. The overlay tunnels 210 provide logical paths for data transmission between the branches 204 and the data centers 208, potentially spanning across multiple physical network devices and links. For example, the overlay tunnels 210 may be virtual private network (VPN) tunnels, providing secure communication channels to the host devices 106. As subsequently described, the orchestrator service 120 may monitor the status of the overlay tunnels 210 to detect connectivity issues and initiate failover procedures for the SD-WAN overlay 202.

The data centers 208 (including the primary data center 208A and the secondary data center 208B) may provide redundancy and load balancing capabilities within the SD-WAN configuration 200. In normal operation for a branch 204, as depicted in FIG. 2A, the primary data center 208A may handle the majority of network traffic for the branch 204 through the first overlay tunnel 210A. Specifically the orchestrator service 120 configures a routing path 114 to establish a logical connection between the branch 204 and the core 206 through the primary data center 208A and the first overlay tunnel 210A. The secondary data center 208B and the second overlay tunnel 210B may be inactive during this normal operation, as represented by dashed lines in FIG. 2A. The orchestrator service 120 may monitor the status of the first overlay tunnel 210A connecting the branch 204 to the primary data center 208A. If a connectivity issue with the branch 204 is detected, the orchestrator service 120 may initiate a failover process for that branch 204. This failover process is illustrated in FIG. 2B, where the first overlay tunnel 210A is shown as a dashed line, indicating its inactive state, while the second overlay tunnel 210B becomes active. During failover, the orchestrator service 120 may redirect the network traffic for the affected branch 204 through the secondary data center 208B via the now-active second overlay tunnel 210B. This per-branch failover mechanism may help maintain network uptime for the affected branch 204 in the event of a failure of its connection to the primary data center 208A. The failover process essentially reconfigures the routing path 114 to reestablish the logical connection between the affected branch 204 and the core 206 through the secondary data center 208B and the second overlay tunnel 210B. Meanwhile, other branches may continue using the primary data center 208A if their respective first overlay tunnels 210A remain stable.

As previously noted, the traffic within the network includes control traffic and data traffic. The data traffic for the branches 204 may be directed through one of the primary data center 208A or the secondary data center 208B, as previously described. However, control traffic (specifically, route advertisements) may be generated for both the primary data center 208A and the secondary data center 208B, regardless of which is being used for data traffic at a given moment. For example, when the primary data center 208A is transiting data traffic for a branch 204, control traffic advertising the routes associated with the branch 204 may still be generated for both the primary data center 208A and the secondary data center 208B, even though the secondary data center 208B is not transiting data traffic for the branch 204. If these route advertisements were sent to the secondary data center 208B during normal operation, they would be forwarded to other network devices 104, including network devices 104 in the core 206. The forwarding of route advertisements, from the secondary data center 208B to the core 206, for branches 204 which are not using the secondary data center 208B may unnecessarily burden the network devices 104 in the core 206. For example, the network devices 104 in the core 206 may need to process and store these additional route advertisements, potentially consuming significant computational resources and memory. In cases where the core 206 has network devices 104 with limited routing table capacities, receiving route advertisements from both data centers 208 during normal operation may lead to resource exhaustion or degraded performance of the network devices 104 within the core 206. This may result in slower route convergence times, increased latency, and potential packet loss, ultimately impacting the overall performance and reliability of the SD-WAN.

The data centers 208 may implement route aggregation to increase network efficiency and reduce the burden of route advertisements on the core 206. In this process, the active data center 208 (e.g., the primary data center 208A in normal operation) aggregates multiple specific routes from various branches 204 into a smaller number of more general routes before advertising them to the core 206. For example, if the network has 10,000 branches, each advertising ten specific routes, the primary data center 208A may aggregate these 100,000 routes into a smaller number (e.g., 50) of aggregate routes. These aggregate routes may be statically configured based on known subnet ranges that encompass the branch routes. By advertising aggregate routes to the core 206, the routing table size and processing requirements at the core 206 may be reduced.

To avoid exhausting resources of the network devices 104 within the core 206, an intelligent routing management system may be implemented by the orchestrator service 120. The orchestrator service 120 may selectively control the advertisement of routes from the data centers 208 to the core 206. In normal operation of a branch 204, the orchestrator service 120 may direct only the primary data center 208A to advertise routes associated with the branch 204 to the core 206. The orchestrator service 120 may monitor the first overlay tunnel 210A between the branch 204 and the primary data center 208A for connectivity issues. If a loss of connectivity is detected, the orchestrator service 120 may then direct the secondary data center 208B to advertise the routes associated with the affected branch 204 to the core 206. For example, the orchestrator service 120 may hold the route advertisements for the secondary data center 208B until an issue is detected with the first overlay tunnel 210A. The held route advertisements may then be released and sent to the secondary data center 208B for processing and forwarding to the core 206. This approach may defer the processing of route advertisements by the network devices 104 in the core 206 until needed, potentially conserving computational resources and improving overall network efficiency. Additionally, this process essentially reconfigures the routing path 114 to reestablish the logical connection between the affected branch 204 and the core 206 through the secondary data center 208B and the second overlay tunnel 210B, ensuring continuity of network services for the affected branch 204.

The failover process may be configurable. Specifically, the orchestrator service 120 has several configurable parameters, which may be set by an administrator (e.g., using the management interface 128, see FIG. 1) to enhance network stability and reduce churn during flapping of the overlay tunnels 210. Tunnel flapping is a condition where an overlay tunnel 210 rapidly alternates between an up and down state. Tunnel flapping may trigger repeated failover processes, causing network instability and unnecessary route advertisements. The failover process parameters allow for fine-tuned control over failover behavior by the primary data center 208A and the secondary data center 208B.

In some implementations, the failover process parameters include preemption. When preemption is enabled, routes associated with a branch 204 will be re-advertised to the primary data center 208A and withdrawn from the secondary data center 208B once connectivity from the branch 204 to the primary data center 208A (through the first overlay tunnel 210A) is restored. When preemption is disabled, the secondary data center 208B will retain the overlay routes as long as its connectivity is maintained through the second overlay tunnel 210B.

In some implementations, the failover process parameters include a hold time. When a hold time is set, the orchestrator service 120 imposes a minimum hold duration before responding to tunnel down/up notifications from the primary data center 208A. That is, an overlay tunnel 210 may not be considered down until a connectivity issue has been detected for a duration of at least the hold time. Likewise, an overlay tunnel 210 may not be considered up until a connectivity issue has been resolved for a duration of at least the hold time. This delay may affect both the advertisement and withdrawal of the overlay routes.

The hold time may be predetermined or randomized. In some implementations, the hold time is a predetermined hold time, which may be one of the failover process parameters. The predetermined hold time may be specified by an administrator and may have a default value, e.g., 30 seconds. In some implementations, the hold time is a randomized hold time. The randomized hold time may be set up to a maximum configured value, which may be one of the failover process parameters. The randomized hold time may be generated by adding a random offset (which is a randomly selected number up to the maximum configured value) to a predetermined hold time. Utilizing a randomized hold time may reduce network churn during tunnel disruptions; specifically, it may stagger the response to tunnel status changes across multiple branches 204, preventing simultaneous route advertisements or withdrawals that could overwhelm the network devices 104 in the data centers 208 or the core 206. This staggered approach may help smooth out the network load during failover events, reducing the risk of congestion or processing bottlenecks if many branches 204 were to failover simultaneously.

The SD-WAN overlay 202 may be implemented using Virtual Routing and Forwarding (VRF) technology, which allows for multiple isolated routing instances within a single network device or across the network. In this configuration, the SD-WAN overlay 202 may contain multiple VRF segments, each representing a separate routing domain. The load balancing implemented by the orchestrator service 120 may be applied individually to one or more VRF segments, based on specific network requirements. This approach allows for granular control over routing behavior, enabling network administrators to implement different routing and load-balancing strategies for different segments of the network. For example, in a network with five VRF segments, the cloud-based load balancing described herein may be applied to one VRF segment while the other four segments use other routing techniques. Such flexibility allows the SD-WAN configuration 200 to meet diverse application and service requirements within the same SD-WAN overlay 202. The orchestrator service 120 may manage route advertisements for each VRF segment independently, potentially advertising routes for some VRF segments to both the primary data center 208A and the secondary data center 208B, while applying the cloud-based load balancing described herein to other VRF segments. This approach may provide a balance between network efficiency and specific application requirements, allowing for customized routing strategies within a single SD-WAN configuration 200.

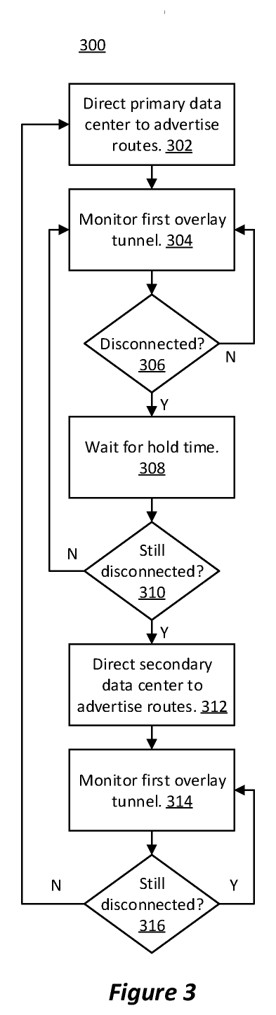

FIG. 3 is a flow diagram of an SD-WAN load balancing method 300, according to some implementations. The SD-WAN load balancing method 300 will be described in conjunction with the network system 100 of FIG. 1 and the SD-WAN configuration 200 of FIGS. 2A-2B. The SD-WAN load balancing method 300 may be implemented by the orchestrator service 120.

The orchestrator service 120 may perform a step 302 of directing the primary data center 208A to advertise routes of the SD-WAN overlay 202 to the core 206. This may include advertising the routes to the primary data center 208A, which may trigger the primary data center 208A to aggregate the routes and forward them to the core 206. Additionally, these routes may be withheld from the secondary data center 208B. The routes being advertised may be associated with a branch 204 of the SD-WAN overlay 202. By advertising these routes, the primary data center 208A may establish a routing path 114 for traffic from the branch 204 through a first overlay tunnel 210A between the branch 204 and the primary data center 208A, as shown in FIG. 2A.

The orchestrator service 120 may perform a step 304 of monitoring the first overlay tunnel 210A for a loss of connectivity. This monitoring may involve checking the status of the first overlay tunnel 210A, which connects the branch 204 to the primary data center 208A. The monitoring may include sending periodic status requests, analyzing traffic flow, receiving status updates from network devices 104 involved in maintaining the first overlay tunnel 210A, or the like.

The orchestrator service 120 may perform a step 306 of determining if the first overlay tunnel 210A is disconnected. This may involve analyzing the data collected during the monitoring step to detect any signs of connectivity loss. If the first overlay tunnel 210A is connected, the orchestrator service 120 returns to step 304 to continue monitoring the first overlay tunnel 210A. If the first overlay tunnel 210A is disconnected, the orchestrator service 120 may perform a step 308 of waiting for a hold time. This hold time may be a predetermined hold time or a randomized hold time (as previously described). During this hold time, the orchestrator service 120 may continue to monitor the status of the first overlay tunnel 210A.

After the hold time has elapsed, the orchestrator service 120 may perform a step 310 of checking if the first overlay tunnel 210A is still disconnected. This serves as a confirmation of the connectivity loss of the first overlay tunnel 210A before initiating failover procedures. If the first overlay tunnel 210A is no longer disconnected, indicating that connectivity has been restored during the hold time, the orchestrator service 120 returns to step 304. Thus, normal operations using the primary data center 208A are resumed.

If the first overlay tunnel 210A is still disconnected, the orchestrator service 120 may perform a step 312 of directing the secondary data center 208B to advertise the routes of the SD-WAN overlay 202 to the core 206. This may include advertising the routes to the secondary data center 208B, which may trigger the secondary data center 208B to aggregate the routes and forward them to the core 206. Additionally, these routes may be withdrawn from the primary data center 208A. The routes being advertised are those associated with the affected branch 204. By advertising these routes, the secondary data center 208B may reestablish the routing path 114 for traffic from the branch 204, except through a second overlay tunnel 210B between the branch 204 and the secondary data center 208B. This effectively completes the failover, redirecting traffic through the secondary data center 208B to maintain network connectivity for the branch 204.

Following the failover, additional steps may optionally be performed. Specifically, if preemption is utilized, the orchestrator service 120 may monitor the first overlay tunnel 210A. If the first overlay tunnel 210A comes back online, the routing path 114 for traffic from the branch 204 may be reestablished through the first overlay tunnel 210A.

The orchestrator service 120 may perform a step 314 of monitoring the first overlay tunnel 210A again. This continued monitoring allows the orchestrator service 120 to detect when connectivity through the primary data center 208A is restored. The monitoring process may be similar to that described in step 304.

The orchestrator service 120 may perform a step 316 of determining if the first overlay tunnel 210A is still disconnected. The monitoring data may be analyzed to check if connectivity has been restored from the branch 204 to the primary data center 208A. If the first overlay tunnel 210A is still disconnected, the orchestrator service 120 returns to step 314 to continue monitoring the first overlay tunnel 210A.

If the first overlay tunnel 210A is no longer disconnected, indicating that connectivity has been restored, the orchestrator service 120 returns to step 302. This allows the orchestrator service 120 to revert to using the primary data center 208A for routing traffic from the branch 204. The orchestrator service 120 may direct the primary data center 208A to resume advertising routes, which may include advertising the routes to the primary data center 208A, triggering aggregation and forwarding to the core 206. At the same time, these routes may be withdrawn from the secondary data center 208B. This may occur potentially after another hold time to ensure stability.

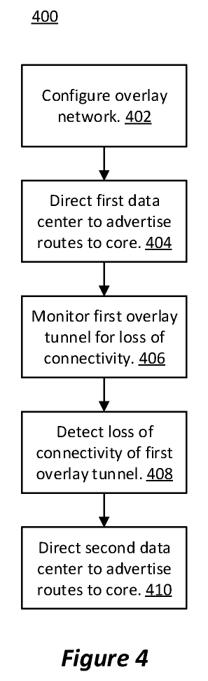

FIG. 4 is a flow diagram of an SD-WAN load balancing method 400, according to some implementations. The SD-WAN load balancing method 400 will be described in conjunction with the network system 100 of FIG. 1 and the SD-WAN configuration 200 of FIGS. 2A-2B. The SD-WAN load balancing method 400 may be implemented by the orchestrator service 120.

The orchestrator service 120 may perform a step 402 of configuring an overlay network 112 to logically connect a first data center 208A, a second data center 208B, a core 206, and a branch 204. The branch 204 may be one of a plurality of geographically distributed branches, and the overlay network 112 may be a software-defined wide area network (SD-WAN) that logically connects the geographically distributed branches 204. The first data center 208A may include first routing equipment, the second data center 208B may include second routing equipment, the core 206 may include third routing equipment, and the third routing equipment may have a smaller routing table capacity than the first routing equipment and the second routing equipment.

The orchestrator service 120 may perform a step 404 of directing the first data center 208A to advertise routes of the overlay network 112 to the core 206. The routes may be associated with the branch 204. The routes advertised by the first data center 208A may establish a routing path 114 for traffic from the branch 204 through a first overlay tunnel 210A between the branch 204 and the first data center 208A. The branch 204 may include a client, the core 206 may include an application server, and the routing path 114 may connect the client to the application server.

In some implementations, the orchestrator service 120 may perform a step of configuring the first data center 208A to aggregate the routes of the overlay network 112 before advertising the routes of the overlay network 112 to the core 206. The routes of the overlay network 112 may be within one of a plurality of virtual routing and forwarding segments of the overlay network 112.

The orchestrator service 120 may perform a step 406 of monitoring the first overlay tunnel 210A for a loss of connectivity. This monitoring may include monitoring a status of the first overlay tunnel 210A.

The orchestrator service 120 may perform a step 408 of detecting the loss of connectivity of the first overlay tunnel 210A. In some implementations, after detecting the loss of connectivity, the orchestrator service 120 may wait for a predetermined hold time or a randomized hold time before proceeding to the next step. The randomized hold time may be generated by adding a random offset to a predetermined hold time.

In response to detecting the loss of connectivity of the first overlay tunnel 210A, the orchestrator service 120 may perform a step 410 of directing the second data center 208B to advertise the routes of the overlay network 112 to the core 206. The routes advertised by the second data center 208B may reestablish the routing path 114 for traffic from the branch 204 through a second overlay tunnel 210B between the branch 204 and the second data center 208B. The first overlay tunnel 210A and the second overlay tunnel 210B may be virtual private network tunnels which are different from one another.

After directing the second data center 208B to advertise the routes, the orchestrator service 120 may continue to monitor the first overlay tunnel 210A for a restoration of connectivity. Upon detecting the restoration of connectivity of the first overlay tunnel 210A, the orchestrator service 120 may direct the second data center 208B of the overlay network 112 to stop advertising the routes of the overlay network 112 to the core 206 of the overlay network 112. This may include withholding or withdrawing routes from the second data center 208B.

The intelligent routing management system implemented by the orchestrator service 120 may provide advantages. By improving the flow of control traffic (particularly, route advertisements) among the primary data center 208A, the secondary data center 208B, and the core 206, the orchestrator service 120 may enhance resource utilization in the network system 100. This approach may reduce unnecessary bandwidth usage and reduce operational costs, especially in virtualized environments or when using cloud service providers. The selective advertisement of routes to the core 206 through the primary data center 208A during normal operations, and only through the secondary data center 208B during failover, may help prevent resource exhaustion in the network devices 104 of the core 206. Additionally, this approach may improve the scalability of the SD-WAN overlay 202, allowing it to adapt more effectively to changing network demands without overcommitting resources. The granular control over route advertisements, potentially on a per-VRF segment basis, may further enhance the system's flexibility and efficiency.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A method, implemented by a software-defined networking orchestrator service, the method comprising:
configuring an overlay network to logically connect a first data center, a second data center, a core, and a branch;
directing the first data center to advertise routes of the overlay network to the core, the routes being associated with the branch, wherein the routes advertised by the first data center establish a routing path for traffic from the branch through a first overlay tunnel between the branch and the first data center;
monitoring the first overlay tunnel for a loss of connectivity;
detecting the loss of connectivity of the first overlay tunnel; and
in response to detecting the loss of connectivity of the first overlay tunnel, directing the second data center to advertise the routes of the overlay network to the core, wherein the routes advertised by the second data center reestablish the routing path for traffic from the branch through a second overlay tunnel between the branch and the second data center.

2. The method of claim 1, further comprising:
configuring the first data center to aggregate the routes of the overlay network before advertising the routes of the overlay network to the core.

3. The method of claim 1, further comprising:
waiting for a predetermined hold time after detecting the loss of connectivity of the first overlay tunnel, wherein the second data center is directed to advertise the routes of the overlay network to the core in response to the first overlay tunnel still having the loss of connectivity after the predetermined hold time.

4. The method of claim 1, further comprising:
waiting for a randomized hold time after detecting the loss of connectivity of the first overlay tunnel, wherein the second data center is directed to advertise the routes of the overlay network to the core in response to the first overlay tunnel still having the loss of connectivity after the randomized hold time.

5. The method of claim 4, further comprising:
generating the randomized hold time for the branch by adding a random offset to a predetermined hold time.

6. The method of claim 1, further comprising:
monitoring the first overlay tunnel for a restoration of connectivity;
detecting the restoration of connectivity of the first overlay tunnel; and
in response to detecting the restoration of connectivity of the first overlay tunnel, directing the second data center of the overlay network to stop advertising the routes of the overlay network to the core of the overlay network.

7. The method of claim 1, wherein the routes of the overlay network are within one of a plurality of virtual routing and forwarding segments of the overlay network.

8. The method of claim 1, wherein monitoring the first overlay tunnel for the loss of connectivity comprises:
monitoring a status of the first overlay tunnel.

9. The method of claim 1, wherein the branch comprises a client, the core comprises an application server, and the routing path connects the client to the application server.

10. The method of claim 1, wherein the first overlay tunnel and the second overlay tunnel are virtual private network tunnels.

11. The method of claim 1, wherein the branch is one of a plurality of geographically distributed branches, and the overlay network is a software-defined wide area network (SD-WAN) that logically connects the geographically distributed branches.

12. A system comprising:
a first data center;
a second data center;
a core; and
a software-defined networking orchestrator service configured to:
configure an overlay network to logically connect the first data center, the second data center, the core, and a branch;
direct the first data center to advertise routes of the overlay network to the core, the routes being associated with the branch, wherein the routes advertised by the first data center establish a routing path for traffic from the branch through a first overlay tunnel between the branch and the first data center;
monitor the first overlay tunnel for a loss of connectivity;
detect the loss of connectivity of the first overlay tunnel; and
in response to detecting the loss of connectivity of the first overlay tunnel, direct the second data center to advertise the routes of the overlay network to the core, wherein the routes advertised by the second data center reestablish the routing path for traffic from the branch through a second overlay tunnel between the branch and the second data center.

13. The system of claim 12, wherein the first data center is configured to aggregate the routes of the overlay network before advertising the routes of the overlay network to the core.

14. The system of claim 12, wherein the software-defined networking orchestrator service is further configured to:
wait for a hold time after detecting the loss of connectivity of the first overlay tunnel, wherein the second data center is directed to advertise the routes of the overlay network to the core in response to the first overlay tunnel still having the loss of connectivity after the hold time.

15. The system of claim 12, wherein the software-defined networking orchestrator service is further configured to:
monitor the first overlay tunnel for a restoration of connectivity;
detect the restoration of connectivity of the first overlay tunnel; and
in response to detecting the restoration of connectivity of the first overlay tunnel, direct the second data center of the overlay network to stop advertising the routes of the overlay network to the core of the overlay network.

16. The system of claim 12, wherein the routes of the overlay network are within one of a plurality of virtual routing and forwarding segments of the overlay network.

17. The system of claim 12, wherein the branch comprises a client, the core comprises an application server, and the routing path connects the client to the application server.

18. The system of claim 12, wherein the first overlay tunnel and the second overlay tunnel are virtual private network tunnels.

19. The system of claim 12, wherein the first data center comprises first routing equipment, the second data center comprises second routing equipment, the core comprises third routing equipment, and the third routing equipment has a smaller routing table capacity than the first routing equipment and the second routing equipment.

20. A device comprising:
a processor; and
a non-transitory computer readable medium storing instructions which, when executed by the processor, cause the processor to:
configure an overlay network to logically connect a first data center, a second data center, a core, and a branch;
direct the first data center to advertise routes of the overlay network to the core, the routes being associated with the branch, wherein the routes advertised by the first data center establish a routing path for traffic from the branch through a first overlay tunnel between the branch and the first data center;
monitor the first overlay tunnel for a loss of connectivity;
detect the loss of connectivity of the first overlay tunnel; and
in response to detecting the loss of connectivity of the first overlay tunnel, direct the second data center to advertise the routes of the overlay network to the core, wherein the routes advertised by the second data center reestablish the routing path for traffic from the branch through a second overlay tunnel between the branch and the second data center.
